(19) United States
(12) Patent Application Publication
(10) Pub. No.: US 2003/0076437 A1
(43) Pub. Date: Apr. 24, 2003

(54) Image capturing apparatus

(75) Inventors: Toshihiko Karasaki, Kawachinagano-Shi (JP); Noriyuki Okisu, Osakasayama-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/271,295

(22) Filed: Oct. 15, 2002

(30) Foreign Application Priority Data
Oct. 18, 2001 (JP) P2001-320490

(51) Int. Cl. H04N 5/232

(52) U.S. Cl. 348/347; 348/350

(57) ABSTRACT

An object of the present invention is to obtain an image capturing apparatus having a function capable of setting a focus position in a subject not only in a position in the center of a frame, with improved operability on confirmation of a focus state after an AF area is moved. In a digital camera as an example of the image capturing apparatus, an AF cursor CR on a display screen moves horizontally/vertically to change the focus point by an operation input of a four-way switch by the user. Interlockingly with the movement of the AF cursor CR, a live view AF process is executed with respect to the changed focus point. An image on the screen of the display is updated after the live view AF process, thereby displaying an image of the subject focused in the position of the designated AF cursor CR on the screen of the display.

This application is based on application No. 2001-320490 filed in Japan, the contents of which are hereby incorporated by reference.

### BACKGROUND OF THE INVENTION

1. Field of the Invention

The present invention relates to an image capturing apparatus having a function capable of setting a focus position in a subject not only in the center of a frame.

2. Description of the Background Art

Japanese Unexamined Patent Publication No. 3-187580 discloses a conventional digital camera having the function capable of setting a focus position in a subject not only in the center of a frame. This conventional digital camera has the function capable of optionally setting a position of an AF area in a frame by the user by designating the maximum and minimum values of coordinates in the X-axis direction (frame vertical direction) of the AF area and the maximum and minimum values of coordinates of the Y-axis direction (frame horizontal direction) by a switch operation or by designating the size of the AF area and the center coordinates.

However, the publication does not disclose the relation between movement of the AF area and the timing of actually driving a lens. When it is assumed that the lens is driven by touching a shutter start button like in a normal digital camera, to confirm a focus state in the AF area after moving the AF area, the shutter start button has to be touched each time. Consequently, the operability is considerably poor. In other words, the conventional digital camera disclosed in the publication has a problem such that the function of recognizing the focus state is insufficient.

### SUMMARY OF THE INVENTION

The present invention is directed to an image capturing apparatus.

According to the present invention, an image capturing apparatus includes: an image sensor for capturing an image of a subject and generating image data; a display for displaying an image based on the image data generated by the image sensor onto a screen; a designating member for designating a focus position in the subject by moving a focus position designation indication on the screen; and a focus controller for performing a focusing operation on the focus position designated by the designating member. The focus controller executes a first focusing operation on the focus position designated by the designating member in a preview state before actual image pickup.

Consequently, when the focus position designation indication is moved by the designating member in a preview state, the first focusing operation on the focus position designated by the designating member is executed. The image of the subject after the first focusing operation is performed is displayed on the screen of the display. As a result, improvement in operability on confirmation of the focus state after the focus position designation indication is moved can be achieved.

In one preferred aspect of the present invention, the focus controller executes the first focusing operation interlockingly with the movement of the focus position designation indication by the designating member.

According to the aspect, when the focus position designation indication is moved by the designating member in a preview state, interlockingly, the focus controller performs the first focusing operation, and the image of the subject after the first focusing operation is performed is displayed on the screen of the display. Consequently, the focus state can be confirmed interlockingly with the movement of the focus position designation indication, and improvement in operability can be achieved.

In another preferred aspect of the present invention, the image capturing apparatus further includes a timer. When another focus position is not designated by the designating member before predetermined time elapses since the designation of the focus position by the designating member, the focus controller executes the first focusing operation.

According to the aspect, the focus controller does not perform the first focusing operation each time the focus position designation indication is moved. After the predetermined time elapses since the focus position designation indication is moved and it can be determined that the focus position is designated with reliability, the focus controller performs the first focusing operation. Therefore, the focus controller can be prevented from executing an unnecessary focusing operation.

In yet another preferred aspect of the present invention, the image capturing apparatus further includes an image capture instructing member for instructing actual image capture. When actual image capture is instructed by the image capture instructing member, the focus controller executes a second focusing operation on the focus position designated by the designating member.

According to the aspect, when actual image capture is instructed, the focus controller newly performs the second focusing operation separately from the first focusing operation. Therefore, even in the case such that the image capturing conditions or the subject change during a transition from the preview mode to an actual image capturing mode, focus can be achieved with reliability by the second focusing operation.

In still another preferred aspect of the present invention, the focus controller executes the second focusing operation when actual image capture is instructed by the image capture instructing member before predetermined time elapses since designation of the focus position by the designating member.

According to the aspect, when the actual image capture instruction is given before elapse of the predetermined time since the focus position designation indication is moved, the focus controller performs the second focusing operation. Therefore, the actual image capturing operation is started without waiting for elapse of the predetermined time, so that the user does not miss the perfect moment for a good picture.

In still another preferred aspect of the present invention, the first focusing operation is performed in a state where the aperture is open.

According to the aspect, the first focusing operation is performed under the condition that the depth of field becomes the shallowest in connection with the f-number. Therefore, when focus is achieved once by the first focusing operation, the possibility that the focus state is maintained without performing the second focusing operation is high. As a result, the possibility that the second focusing operation is unnecessary is high.

In still another preferred aspect of the present invention, the display displays an image of a subject subjected to the second focusing operation onto the screen.

According to the aspect, by displaying the image of the subject subjected to the second focusing operation on the screen, the user can make a final check on the focus state of the image to be captured.

In still another preferred aspect of the present invention, the image capturing apparatus further includes a zoom operating member for performing a zooming operation of an imaging lens, and the focus controller executes the second focusing operation when the zoom operating member is operated after the first focusing operation is performed.

According to the aspect, when the zoom magnification is changed after the first focusing operation is performed, the second focusing operation is performed. Consequently, even in the case where the focus position in the subject after changing the zoom magnification becomes different from that when the first focusing operation is performed, by newly performing the second focusing operation, focus can be achieved on a desired position in the subject.

In still another preferred aspect of the present invention, the focus controller does not perform a focusing operation at the time of actual image capture.

According to the aspect, the image of the subject is captured by using a result of the first focusing operation in the preview state, and another focusing operation is not newly performed in actual image capture. Therefore, the image of the subject can be captured quicker since the focusing operation is not performed in the actual image capture, so that the possibility that the user misses the perfect moment for a good picture can be lowered.

In still another preferred aspect of the present invention, the image capturing apparatus further includes a detector for detecting luminance of the subject in a focus position designated by the designating member.

In still another preferred aspect of the present invention, when the luminance of the subject in the focus position designated by the designating member is equal to or lower than a predetermined value, the focus controller does not execute the first focusing operation.

According to the aspect, when the position where the luminance of the subject is equal to or lower than the predetermined value is designated as a focus position, the first focusing operation is not performed. Consequently, unnecessary focusing operation in the position where the luminance level is low can be prevented from being performed.

The present invention has been achieved in consideration of the problems of the conventional technique, and its object is to obtain an image capturing apparatus having a function capable of setting a focus position in a subject not only in the center of a frame, with improved operability on confirmation of the focus state after moving an AF area.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a structure of a digital camera according to a first embodiment of the present invention;

FIG. 2 is a rear view showing the structure of the digital camera according to the first embodiment of the present invention;

FIG. 3 is a side view showing the structure of the digital camera according to the first embodiment of the present invention;

FIG. 4 is a bottom view showing the structure of the digital camera according to the first embodiment of the present invention;

FIG. 5 is a block diagram showing an internal configuration of the digital camera according to the first embodiment of the present invention;

FIG. 6 is a block diagram concretely showing a part of the internal configuration of the digital camera according to the first embodiment of the present invention;

FIG. 7 is a conceptual diagram for describing a live view display;

FIG. 8 is a block diagram concretely showing a part of the internal configuration of the digital camera according to the first embodiment of the present invention;

FIG. 9 is a schematic diagram for describing metering in a digital camera;

FIG. 10 is a schematic diagram for describing metering in the digital camera;

FIG. 11 is a schematic diagram for describing metering in the digital camera;

FIG. 12 is a schematic diagram for describing a zoom operation in a digital camera;

FIG. 13 is a state transition diagram showing basic operations in the digital camera according to the first embodiment of the present invention;

FIG. 14 is a schematic diagram showing an example of a display screen of an LCD;

FIG. 15 is a schematic diagram showing an example of the display screen of the LCD in the case where optical zoom is performed;

FIG. 16 is a schematic diagram showing an example of the display screen of the LCD in the case where electronic zoom is performed;

FIG. 17 is a flowchart for concretely describing operations of the digital camera according to the first embodiment of the present invention;

FIG. 18 is a flowchart for concretely describing operations of the digital camera according to the first embodiment of the present invention;

FIG. 19 is a diagram for describing depth of field;

FIG. 20 is a diagram for describing depth of field; and

FIG. 21 is a diagram for describing depth of field.

### DESCRIPTION OF THE PREFERRED EMBODIMENTS

Hereinafter, preferred embodiments of the present invention will be described in detail with reference to the drawings. In the following, an embodiment regarding a digital camera will be described as an example of an image capturing apparatus.

Configuration of Main Components of Digital Camera

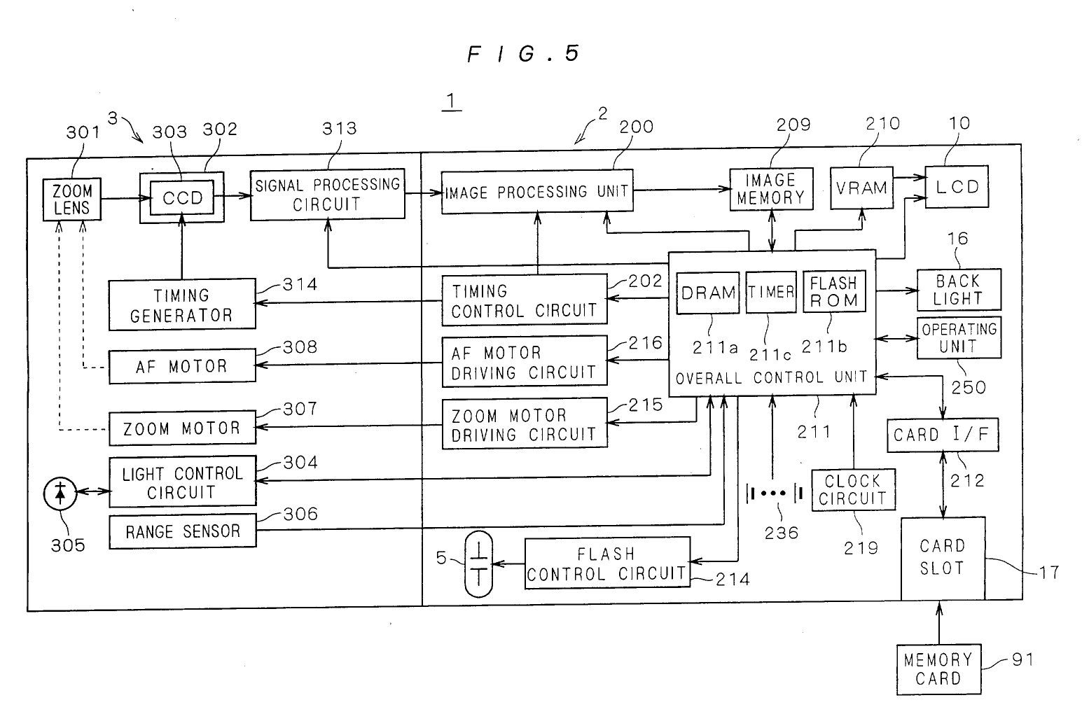

FIGS. 1 to 4 are a front view, a rear view, a side view and a bottom view of a digital camera 1 according to an embodiment of the present invention, respectively. FIG. 5 is a block diagram showing an internal configuration of the digital camera 1.

The digital camera 1 is constructed by, as shown in FIG. 1, a box-shaped camera body part 2 and an image capturing part 3 of a rectangular parallelepiped shape (indicated by thick lines in FIGS. 1, 2 and 4). The image capturing part 3 has a zoom lens 301 with a macro function as an image pickup lens and, in a manner similar to a lens shutter camera using a silver halide film (hereinafter, referred to as a “silver halide-film camera”), a light control sensor 305 for receiving reflected light of flash light from a subject, and an optical viewfinder 31. The zoom lens 301 can zoom in and out on a subject in a range of focal length from 35 mm to 70 mm in terms of the silver halide-film camera using a 35 mm film.

The image capturing part 3 has therein a CCD 303 (see FIG. 5) as a CCD color area sensor functioning as image capturing means in a position rearward of the zoom lens 301, and the CCD 303 is a part of an image capturing circuit 302.

As shown in FIG. 1, in the front face of the camera body part 2, a grip part 4 is provided at the left end, a built-in flash 5 is provided in the center of the upper portion, and a shutter start button 8 is provided on the top face.

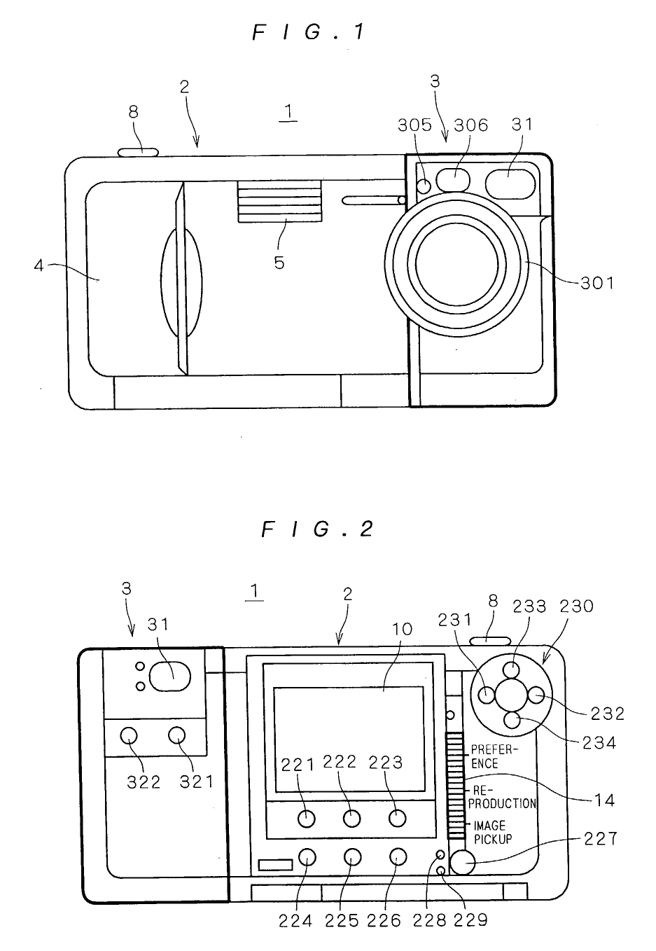

As shown in FIG. 2, in an almost center portion of the rear face of the camera body part 2, an LCD 10 for displaying a captured image on a monitor (corresponding to a view finder) and reproducing and displaying a recorded image is provided. The LCD 10 has a display screen having 400 pixels in the lateral direction and 300 pixels in the vertical direction. Below the LCD 10, a group of key switches 221 to 226 for performing operations on the digital camera 1 and a power supply switch 227 are provided. The key switch 224 functions as a magnification display button. The key switch 225 functions as an AF cursor button for displaying an AF cursor CR (focus designation display) for designating the focus position in a subject on the LCD 10. The key switch 226 functions as a menu button. On the left side of the power supply switch 227, an LED 228 which is turned on when the power source is turned on, and an LED 229 indicating that a memory card is being accessed are disposed.

On the rear face of the camera body part 2, a mode setting switch 14 for switching a mode among an “image pickup mode”, a “reproduction mode” and a “preference mode” is provided (see FIG. 2). The image pickup mode is a mode of taking a picture. The reproduction mode is a mode of reproducing a captured image recorded in the memory card and displaying the image on the LCD 10. Further, the preference mode is a mode of making various settings by selecting one of display items (setting items) displayed on the LCD 10.

The mode setting switch 14 is a slide switch of three contacts. In FIG. 2, when the mode setting switch 14 is set to the down, the image pickup mode is set. When the mode setting switch 14 is set to the center, the reproduction mode is set. When the mode setting switch 14 is set to the up, the preference mode is set.

In the right side of the rear face of the camera, a four-way switch 230 is provided. By depressing buttons 231 and 232 in the image pickup mode, zooming of changing the focal length of the zoom lens 301 to change the zoom magnification is performed. By depressing buttons 233 and 234, exposure correction can be manually performed. In an image pickup standby state in the image pickup mode (which is a state where live view display of moving images is performed on the LCD 10 and is also referred to as a “preview mode”), the AF cursor CR can be moved up, down, right or left by the operation of the four-way switch 230.

On the rear face of the image capturing part 3, as shown in FIG. 2, an LCD button 321 for turning on/off the LCD 10 and a macro button 322 are provided. When the LCD button 321 is depressed, the on/off state of the LCD display is switched. For example, in the case of capturing an image only by using the optical viewfinder 31, the LCD display is turned off to save power. At the time of macro image pickup, by depressing the macro button 322, an AF motor 308 (see FIG. 5) is driven and the zoom lens 301 can perform macro image pickup.

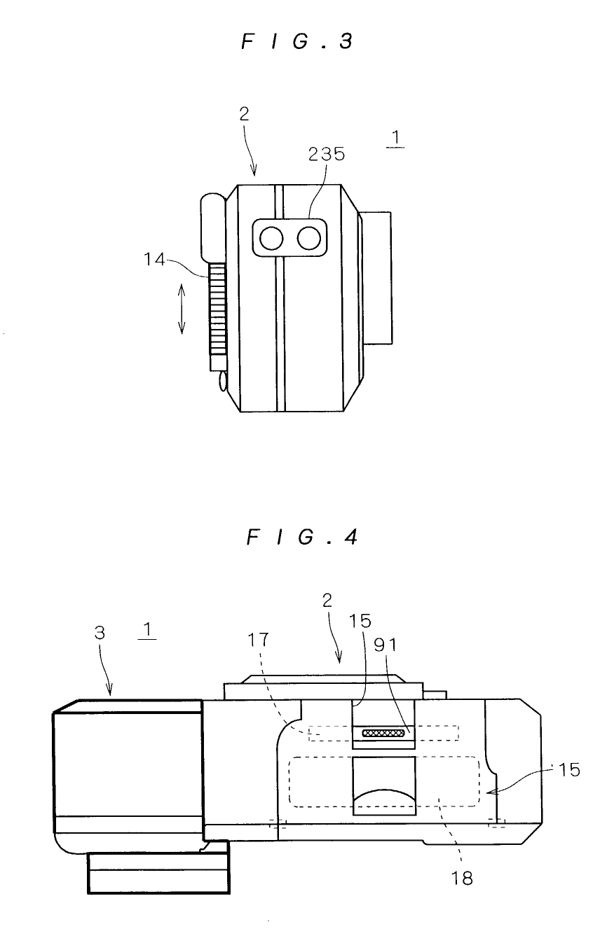

On a side face of the camera body part 2, a DC input terminal 235 is provided as shown in FIG. 3.

In the bottom face of the camera body part 2, as shown in FIG. 4, a battery loading room 18 and a card loading room 17 (card slot) are provided. A memory card 91 or the like can be loaded in the card loading room 17. The card loading room 17 can be closed by a clamshell-type cover 15.

In the digital camera 1, by loading four AA cells to the battery loading room 18, a power supply battery 236 (see FIG. 5) obtained by connecting the four AA cells in series is used as a drive source. Obviously, the power from an adapter can be supplied from the DC input terminal 235 shown in FIG. 3.

The internal configuration of the image capturing part 3 will now be described by referring to FIG. 5.

The image capturing circuit 302 photoelectrically converts an optical image of a subject formed on the CCD 303 by the zoom lens 301 by using the CCD 303, and outputs the resultant as image data (signals of signal columns of pixel signals received by pixels) of color components of R (red), G (green) and B (blue). The CCD 303 has 1600 pixels in the lateral direction and 1200 pixels in the vertical direction.

Since the f-number can be set in a several stages in the digital camera 1 by a key operation of the user. Exposure control in the image capturing part 3 is performed by adjusting an exposure amount of the CCD 303 (charge accumulation time of the CCD 303 corresponding to a shutter speed). When the brightness of the subject is low and an appropriate shutter speed cannot be set, improper exposure due to insufficient exposure is corrected by adjusting the level of an image signal outputted from the CCD 303. In other words, at the time of low brightness, exposure control is performed by combining the shutter speed and gain adjustment. The level of an image signal is adjusted by an AGC (Auto Gain Control) circuit in a signal processing circuit 313 which will be described later. Metering in the automatic exposure (AE) will be described in detail later.

A timing generator 314 generates a drive control signal of the CCD 303 synchronously with a clock transmitted from a timing control circuit 202 in the camera body part 2. The timing generator 314 generates, for example, timing signals of start and end of integration (that is, start and end of exposure) and clock signals such as read control signals (a horizontal sync signal, a vertical sync signal, a transfer signal and the like) of received light signals of pixels and outputs the signals to the CCD 303.

The signal processing circuit 313 performs a predetermined analog signal process on an image signal (analog signal) outputted from the image capturing circuit 302. The signal processing circuit 313 has therein, although not shown, a CDS (Correlated Double Sampling) circuit and an AGC circuit. Noise of an image signal is reduced by the CDS circuit and the gain of the AGC circuit is adjusted, thereby adjusting the level of an image signal.

The light control circuit 304 controls the light emission amount of the built-in flash 5 in image pickup with a flash to a predetermined light emission amount set by an overall control unit 211 in the camera body unit 2. In image pickup with a flash, reflection light of flash light from the subject is received by the light control sensor 305 simultaneously with start of exposure. When the received light amount reaches a predetermined light emission amount, a flash stop signal is outputted from the light control circuit 304 to the flash control circuit 214 in the camera body part 2 via the overall control unit 211. In response to the flash stop signal, the flash control circuit 214 forcedly stops flash of the built-in flash 5, thereby controlling the light emission amount of the built-in flash 5 to the predetermined light emission amount.

The image capturing part 3 has therein a zoom motor 307 for changing a zoom ratio of the zoom lens 301 and moving the lens between a housing position and an image pickup position, and an AF (auto focus) motor 308 for achieving a focus. The AF control will be described in detail later.

The internal configuration of the camera body part 2 will now be described.

The overall control unit 211 is constructed mainly by a CPU and controls an image pickup operation of the digital camera 1 by controlling driving of peripheral devices in the image capturing part 3 and the camera body part 2 connected via an address bus, a data bus and a control bus.

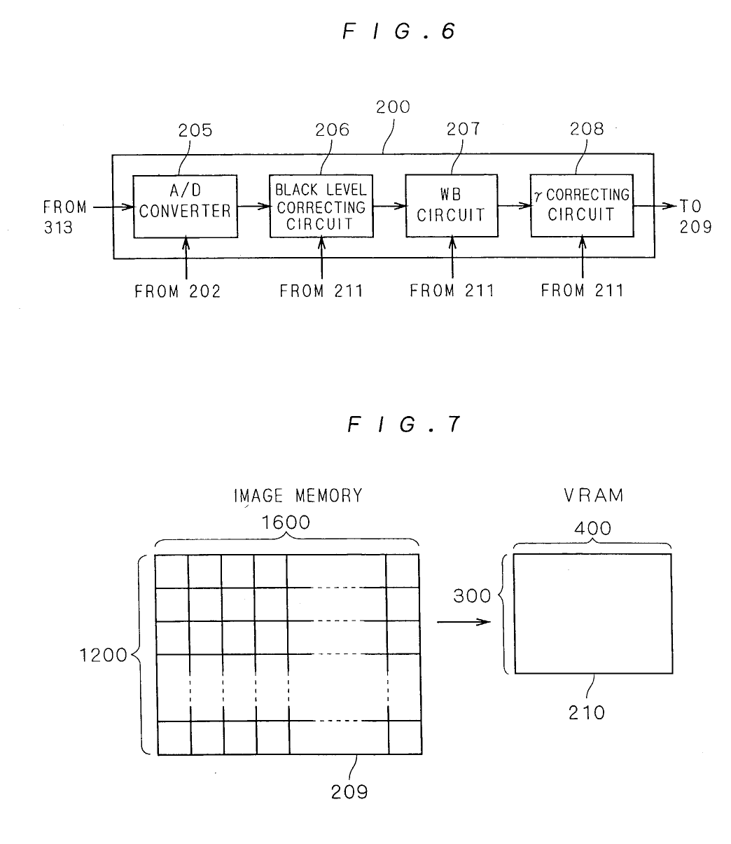

The flow of image data in FIG. 5 (and FIG. 6 which will be described later) is indicated by arrows connecting the peripheral devices for convenience. In practice, image data is transmitted to each peripheral device via the overall control unit 211. The overall control unit 211 has therein a work RAM 211a taking the form of a DRAM and a flash ROM 211b for storing a program. Further, the overall control unit 211 has therein a timer 211c for specifying a timing of executing a live view AF process which will be described later.

The process of an image signal and the configuration related to image display in the camera body part 2 will now be described.

An analog image signal outputted from the signal processing circuit 313 of the image capturing part 3 is inputted to an image processing unit 200 in the camera body part 2 and subjected to various image processes in the image processing unit 200. FIG. 6 is a block diagram showing the configuration of the image processing unit 200. First, the analog image signal transmitted to the image processing unit 200 is converted to a digital signal of 10 bits per pixel in an A/D converter 205. The A/D converter 205 converts each pixel signal (analog signal) to a digital signal of 10 bits on the basis of a clock for A/D conversion inputted from the timing control circuit 202.

The timing control circuit 202 generates a reference clock and clocks for the timing generator 314 and the A/D converter 205 under control of the overall control unit 211.

A black level correcting circuit 206 corrects the black level of an A/D converted pixel signal (hereinafter, referred to as “pixel data”) to a reference black level. A WB circuit 207 performs level shifting of pixel data of each of color components of R, G and B, and executes automatic white balance adjustment (AWB) in consideration of γ correction in a post process. The white balance is adjusted by using a level shifting table (to be accurate, data of the table) inputted from the overall control unit 211 to the WB circuit 207. A color component shift coefficient (gradient of characteristic) of the level shifting table is set for each captured image by the overall control unit 211.

A γ correcting circuit 208 corrects the γ characteristic of pixel data. An output from the γ correcting circuit 208 is transmitted to an image memory 209 as shown in FIG. 5.

The image memory 209 is a memory for storing pixel data outputted from the image processing unit 200 and has a storage capacity of at least one frame an image. Specifically, when the CCD 303 has 1600×1200 pixels arranged in a matrix, the image memory 209 has a storage capacity of pixel data of 1600×1200 pixels, and each pixel data is stored in a corresponding storage area (address).

A VRAM 210 is a buffer memory of image data reproduced and displayed on the LCD 10. The VRAM 210 has a storage capacity of image data corresponding to 400×300 pixels of the LCD 10, that is, a capacity of 400×300 pixels.

With such a configuration, in an image pickup standby mode in the image pickup mode, each of pixel data of an image captured every predetermined interval by the image capturing part 3 is processed by the image processing unit 200, stored in the image memory 209, transferred to the VRAM 210 via the overall control unit 211, and displayed on the LCD 10. In such a manner, live view display of displaying an image of a subject before image pickup like moving images on the LCD 10 can be performed.

In the live view display, when image data is read from the CCD 303 having light receiving devices of 1600 pixels in the lateral direction and 1200 pixels in the vertical direction, image data is reduced to ¼ in the vertical direction and the resultant image data of 1600×300 pixels is outputted from the CCD 303 and inputted to the image memory 209. The image data of 1600 pixels in the lateral direction and 300 pixels in the vertical direction is reduced to ¼ in the lateral direction by the overall control unit 211. As a result, as shown in FIG. 7, the image data of 400×300 pixels out of the image data of 1600×1200 pixels is transferred to the VRAM 210. The mode in which the number of pixels is reduced to ¼ is referred to as a “draft mode”. In contrast, a mode in which reduction to ¼ is not performed is referred to as an “all pixels reading mode”.

The live view display is performed in the draft mode. When the shutter start button 8 is touched (S1) during the live view display, the program shifts to the all pixels reading mode. After completion of image pickup by full depression (S2), the program shifts again to the draft mode and the live view display is performed.

When the enlarging display button 224 is pressed in the live view display, the CCD drive signal of the timing generator 314 is switched, and the program shifts to the all pixels reading mode. Image data of 400×300 pixels in the image memory 209 is cut out and transferred to the VRAM 210, thereby the image being enlarged by four times in the vertical and lateral directions. As described above, by depressing the enlarging display button 224, the user can easily switch an image between the image captured by the CCD 303 and its enlarged image on the LCD 10.

In the reproduction mode, the image read from the memory card 91 is subjected to a predetermined signal process by the overall control unit 211 and, after that, the resultant image is transferred to the VRAM 210 and reproduced and displayed on the LCD 10. At the time of displaying an image on the LCD 10, a back light 16 is turned on by the control of the overall control unit 211.

The other internal configuration of the camera body part 2 will now be described.

A card I/F 212 is an interface for transmitting/receiving a signal to/from the memory card 91 loaded in the card loading room 17. Concretely, via the card I/F 212, image data is written/read to/from the memory card 91.

A flash control circuit 214 is a circuit for controlling light emission of the built-in flash 5 as described above. The flash control circuit 214 controls light emission, a light emission amount, a light emission timing and the like of the built-in flash 5 on the basis of a control signal of the overall control unit 211, and controls the light emission amount of the built-in flash 5 on the basis of a flash stop signal inputted from a light control circuit 304.

A clock circuit 219 is used to manage date and time of image pickup and driven by not-shown another power source.

The camera body part 2 has also therein a zoom motor driving circuit 215 for driving the zoom motor 307 and an AF motor driving circuit 216 for driving the AF motor 308. The circuits function in accordance with an operation of an operating unit 250 constructed by the shutter start button 8 and the above-described various switches and buttons.

For example, the shutter start button 8 is a two-stage switch capable of detecting the touched state (S1) and the depressed state (S2) as employed in a silver halide-film camera. When the shutter start button 8 is touched in the image pickup standby mode, the AF motor driving circuit 216 drives the AF motor 308 to move the zoom lens 301 to a position where focus is achieved.

When the buttons 231 and 232 are depressed, signals from the buttons are transmitted to the overall control unit 211. In accordance with an instruction of the overall control unit 211, the zoom motor driving circuit 215 drives the zoom motor 307 to move the zoom lens, thereby optical zooming being performed.

The components in the camera body part 2 have been described above. The overall control unit 211 performs various functions by software other than transmission/reception of data to/from the peripheral devices and timing control.

For example, the overall control unit 211 has a filtering function, a recording image generating function and a reproduction image generating function to perform a process of recording a captured image.

The filtering function is to correct high frequency components of an image to be recorded by a digital filter, thereby correcting the picture quality regarding an outline.

The recording image generating function is to read pixel data from the image memory 209 and generate a thumbnail image and a compressed image to be recorded on the memory card 91. Concretely, while being scanned in the image memory 209 in a raster scan direction, pixel data is read every 8 pixels in each of the horizontal and vertical directions, and sequentially transferred to the memory card 91, thereby being recorded onto the memory card 91 while generating a thumbnail image. At the time of recording the compressed image data to the memory card 91, all of the pixel data is read from the image memory 209, subjected to two-dimensional DCT, and a predetermined compressing process according to the JPEG system such as Huffman coding, and the resultant is recorded onto the memory card 91.

As a concrete operation, in the image pickup mode, when image pickup is instructed by the shutter start button 8, a thumbnail image of an image stored in the image memory 209 after the instruction of image pickup and an image compressed according to the JPEG system at a set compression ratio are generated and stored into the memory card 91 together with tag information regarding the captured image (information such as frame number, exposure value, shutter speed, compression ratio, date of image pickup, data of the on/off state of flash at the time of image pickup, scene information, and a result of determination of an image).

The reproduction image generating function is a function of generating a reproduction image by decompressing the compressed image recorded on the memory card 91. As a concrete operation, when the mode setting switch 14 is set in the reproduction mode, image data of the largest frame number in the memory card is read and decompressed, and the resultant data is transferred to the VRAM 210. Consequently, on the LCD 10, an image of the largest frame number, that is, an image captured latest is displayed.

Regarding AF

In the digital camera 1, the AF cursor CR corresponding to the AF area is displayed on the LCD 10, which will be described later.

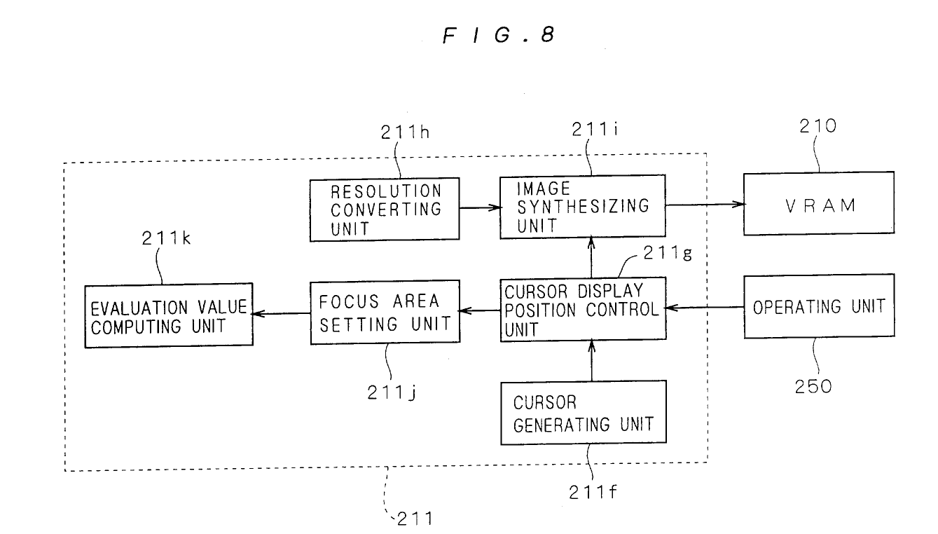

FIG. 8 is a partial block diagram of the digital camera 1.

The overall control unit 211 has a cursor generating unit 211f, a cursor display position control unit 211g, a resolution converting unit 211h, an image synthesizing unit 211i, a focus area setting unit 211j, and an evaluation value computing unit 211k.

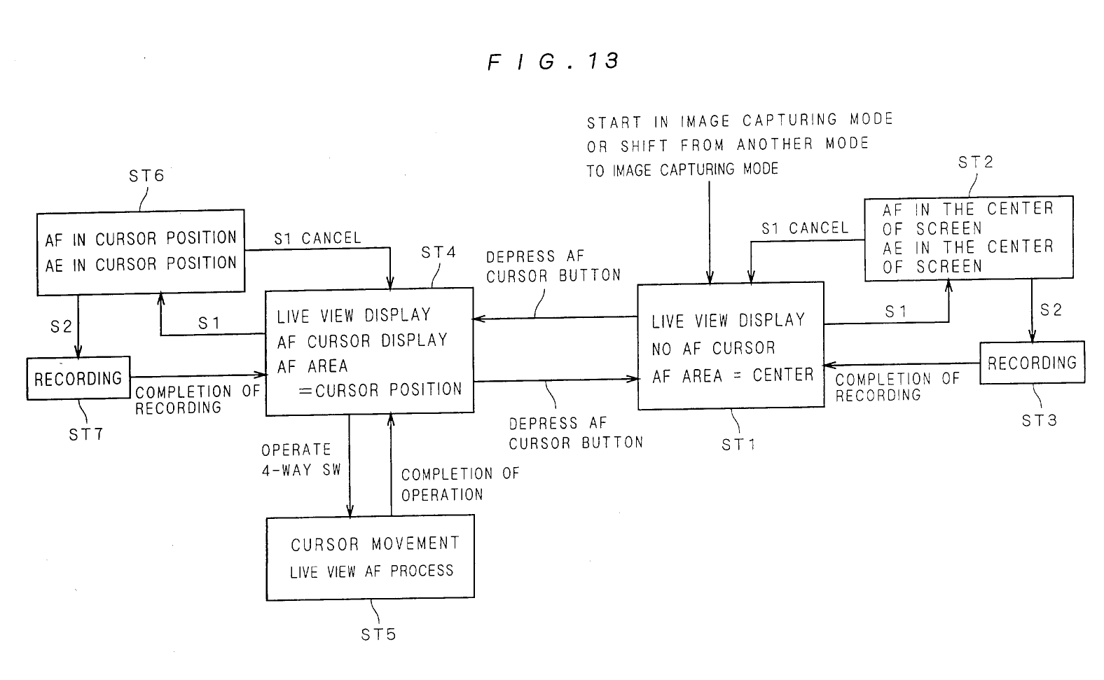

The cursor generating unit 211f reads cursor data for generating the AF cursor CR shown in FIG. 12 on the LCD 10 from the flash ROM 211b and transfers the cursor data to the cursor display position control unit 211g. The AF cursor CR shown in FIG. 12 has a cross shape and a size of 16×16 pixels on the LCD 10. The AF cursor CR does not always have to have a cross shape but may have, for example, a rectangular frame shape like an AF area AR which will be described later.

The cursor display position control unit 211g changes the display position of the AF cursor CR on the LCD 10 on the basis of the operation entered to the operating unit 250 (four-way switch 230) by the operator.

The resolution converting unit 211h generates an image obtained by reducing the image data acquired by the CCD 303 to ¼, and transfers the reduced image to the image synthesizing unit 211i in a normal display mode. On the other hand, in an enlarging display mode, the resolution converting unit 211h transfers a part of the image data acquired by the CCD 303 as it is to the image synthesizing unit 211i.

The image synthesizing unit 211i synthesizes an image inputted from the resolution converting unit 211h and the image of the AF cursor CR inputted from the cursor display position control unit 211g and transmits the synthesized image to the VRAM 210. By the synthesizing operation, the size of the AF cursor CR on the LCD 10 is unchanged irrespective of a reduction ratio of the resolution converting unit 211h. This similarly applies also to the case of electronic zooming.

The focus area setting unit 211j sets the AF area AR used for focusing, which corresponds to the position of the AF cursor CR on the screen of the LCD 10. In an actual image pickup (that is, a state where the shutter start button 8 is fully depressed (S2) and an image is recorded), the AF area AR has a size of 200 pixels in the lateral direction and 80 pixel in the vertical direction in the CCD 303 having 1600 pixels horizontally by 1200 pixels vertically. The AF process in an actual image pickup (hereinafter, referred to as “image pickup AF process”) is performed with the number of pixels of 200×80. The number of pixels of 200 horizontally by 80 vertically corresponds to the size of 50 pixels horizontally by 20 pixels vertically on the screen (400×300) of the LCD 10. At the time of the live view, the number of pixels is reduced to ¼ in each of the horizontal and vertical directions, so that the number of pixels in the AF area AR becomes 50 pixels horizontally by 20 pixels vertically. By using the number of pixels 50×20, an AF process at the time of live view (hereinafter, referred to as “live view AF process”) is performed. The live view AF process is not necessarily performed in the draft mode but also may be performed in the all pixels reading mode.

The evaluation value computing unit 211k performs an evaluation value computing operation for performing AF of a contrast method when the shutter start button 8 is touched by the user (S1) or when the AF cursor CR is moved by a key operation of the user at the time of live view. In this case, with respect to captured image data corresponding to the AF area AR which will be described later, an evaluation value as a sum of absolute values of differences between neighboring pixels is computed. The lens is driven and the lens position in which the evaluation value is the maximum is determined as a focus position. Consequently, the zoom lens 301 is driven to the AF area AR corresponding to the focus position to achieve focus, so that a focus can be achieved on a main subject or the like.

Regarding AE

AE based on center-weighted metering in the position of the AF cursor CR in the LCD 10 screen is performed. In other words, the AF cursor CR also functions as the AE cursor corresponding to the metering point.

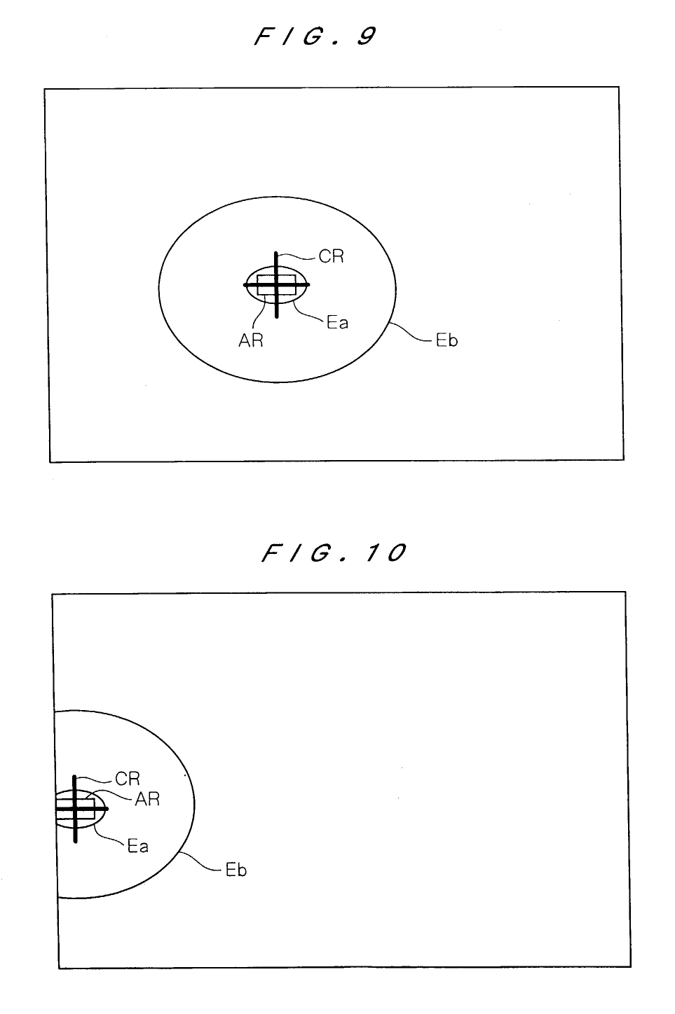

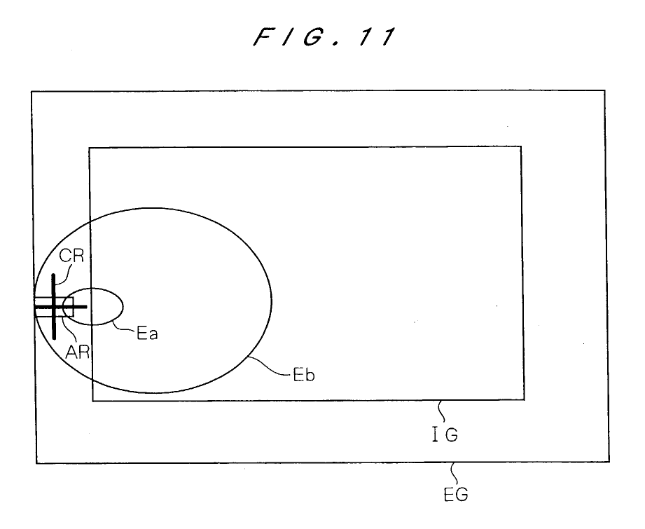

In the metering, as shown in FIG. 9, ellipses Ea and Eb functioning as metering regions are set around the AF cursor CR as a center and, by designating a weighting factor of 8 to the inside of the ellipse Ea and designating a weighting factor of 2 to the area extending from the ellipse Ea to the ellipse Eb, metering computation on image data obtained by the CCD 303 is executed. It enables proper metering on the main subject to be performed.

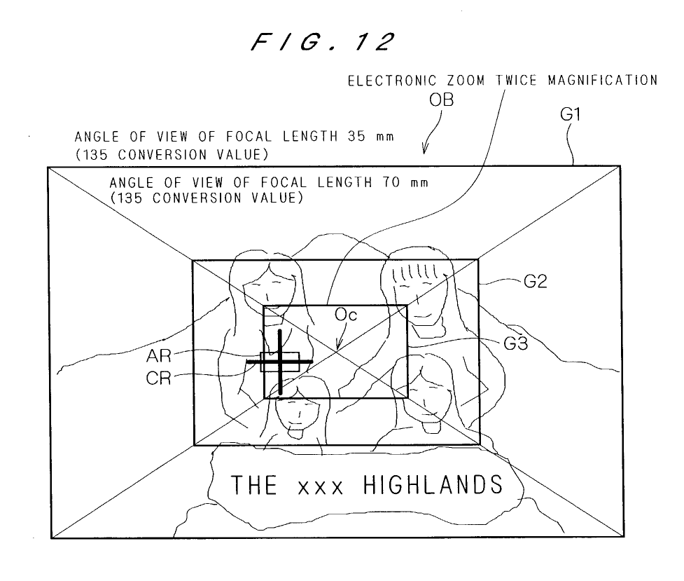

For example, in the case where the main subject is positioned at the end of the screen and the AF cursor CR is positioned at the end of the screen as shown in FIG. 10, if the ellipses Ea and Eb used for metering are set around the AF cursor CR as a center, a part of each of the ellipses Ea and Eb lies off the screen, and balance of the metering deteriorates.

Consequently, as shown in FIG. 11, a rectangular-shaped regulation area IG is set in the center of the screen. When the center of the AF cursor CR lies off the regulation area IG, the center of the ellipse Ea is moved to the end of the regulation area IG and the ellipse Eb is moved so as to be in contact with the periphery of a screen EG. By moving the center of the metering area to the center of the screen more than the AF cursor CR as described above, balanced metering can be performed. When a result of the metering is used, a proper exposure control can be performed.

Operation of Digital Camera 1

The operation of the digital camera 1 will be described later. The operation is automatically executed by the overall control unit 211.

First, zooming of the digital camera 1 will be described.

FIG. 12 is a schematic diagram for describing a zooming operation in the digital camera 1.

A frame G1 shows a state of a subject OB displayed on the LCD 10 in the case of the angle of view where the focal length of the zoom lens 301 is 35 mm (in 135 conversion).

A frame G2 shows a state of the subject OB displayed on the LCD 10 in the case of the angle of view where the focal length of the zoom lens 301 is, different from the case of the frame G1, 70 mm (in 135 conversion). The frames G1 and G2 can be switched by operating the buttons 231 and 232.

A frame G3 shows a state where the subject is doubled by the electronic zoom. In the electronic zoom, for example, original image data of 1600×1200 pixels obtained by the CCD 303 is trimmed to image data of 800×600 pixels and the resultant data is recorded. At this time, the data of 800×600 pixels is reduced to the half and displayed on the LCD 10.

In a change in the zoom magnification, an image is enlarged around the center Oc of the frame as a center.

In each of the frames G1 to G3, by depressing the AF cursor button 225, the AF cursor CR corresponding to the AF area AR is displayed.

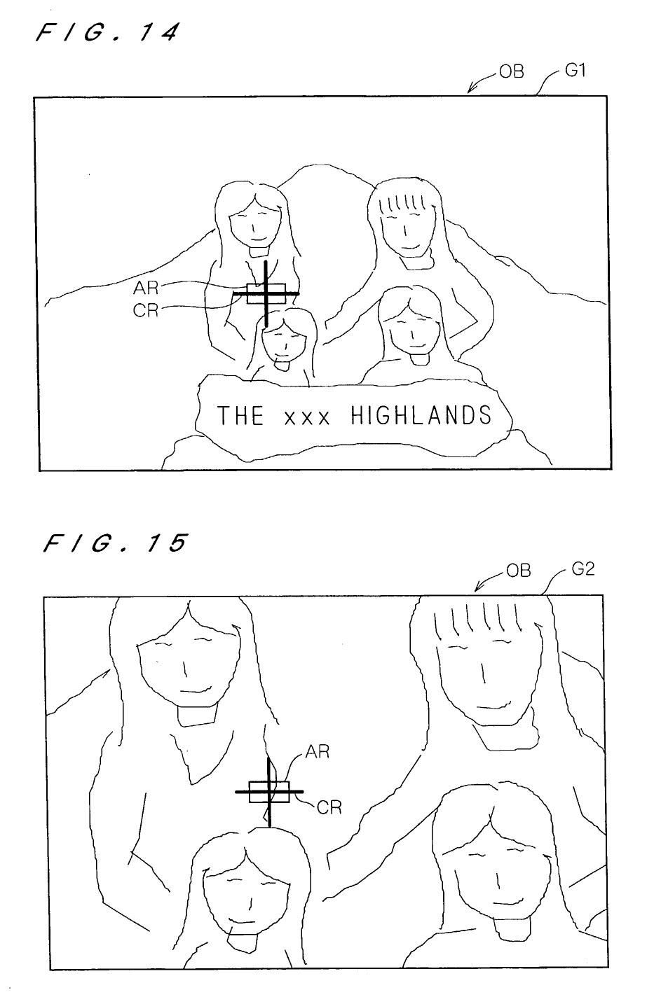

FIG. 13 is a status transition diagram showing the basic operation of the digital camera 1.

In status ST1, a live view is displayed on the LCD 10, the AF cursor CR is not displayed, and the AF area AR is set in the center of the frame of the LCD 10. In status ST1, when an actual image pickup is instructed, that is, when the shutter start button 8 is touched (S1), the digital camera 1 moves to status ST2. In status ST2, AF (image pickup AF process) and AE are performed in the center of the frame of the LCD 10. When the shutter start button 8 is depressed (S2) in status ST2, the digital camera 1 moves to status ST3. In status ST3, the captured image data is recorded on the memory card 91 and, after completion of recording, the digital camera 1 returns to ST1. When the shutter start button 8 is canceled from the touched state (S1) in status ST2, the digital camera 1 also returns status ST1.

When the AF cursor button 225 is depressed in status ST1, the program shifts to status ST4. In status ST4, as shown in FIG. 14, a live view of the subject OB is displayed, and the AF cursor CR is displayed on the frame of the LCD 10. In this case, the center of the AF area AR and that of the AF cursor CR coincide with each other.

When the four-way switch 230 is operated in status ST4, the program shifts to status ST5. In status ST5, the AF cursor CR moves horizontally or vertically by a key operation of the four-way switch 230 by the user, thereby the focus point being changed. Interlocked with the movement of the AF cursor CR, the live view AF process on the changed focus point is executed. After completion of the operation of the four-way switch 230, the program returns to status ST4.

When the shutter start button 8 is touched (S1) in status ST4, the program shifts to status ST6. Status ST6 denotes a status where the AF (image pickup AF process) and AE are performed in the AF cursor CR position in the screen of the LCD 10. When the shutter start button 8 is fully depressed (S2) in status ST6, the program shifts to status ST7. In status ST7, the captured image data is recorded on the memory card 91. After completion of the recording, the program returns to status ST4. Also in the case where the shutter start button 8 is canceled from the state where the shutter start button 8 is touched (S1) in status ST6, the program returns to status ST4.

When the AF cursor button 225 is depressed in status ST4, the program shifts to status ST1.

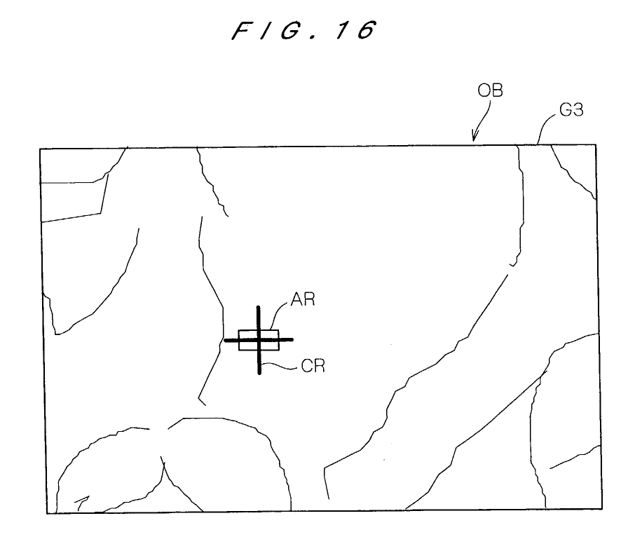

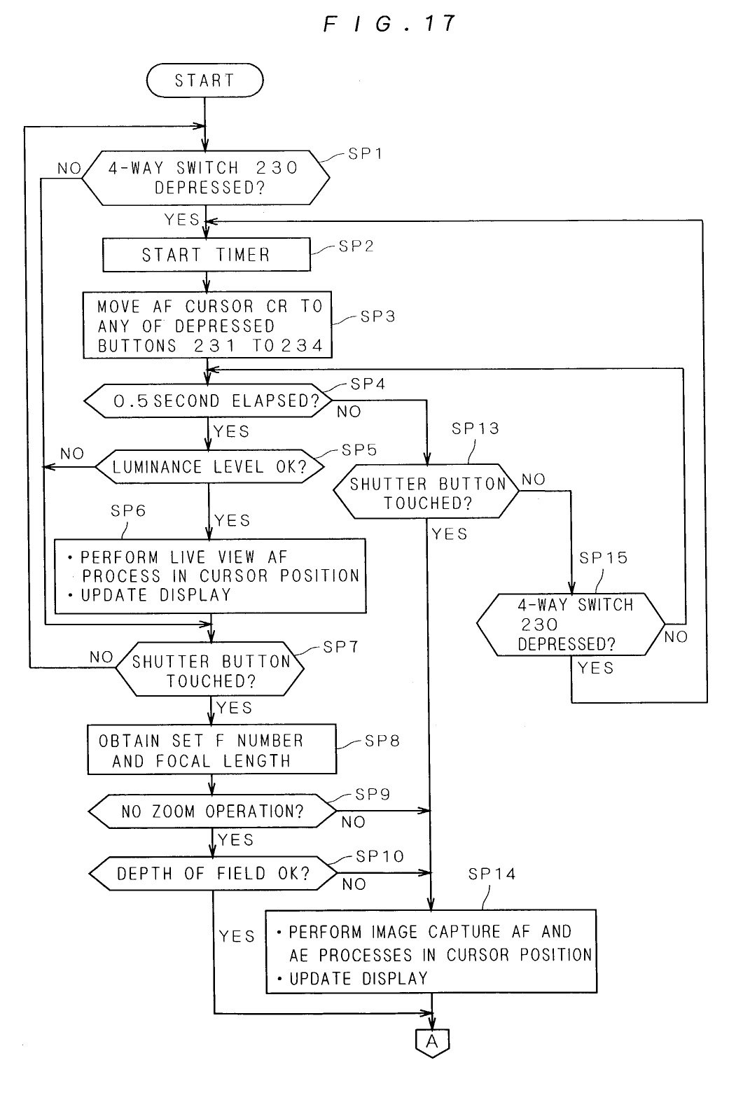

When zooming is performed from the frame G1 into the frame G2 shown in FIG. 12 by an optical zoom operation of the user in status ST4, the subject OB is displayed on the LCD 10 as shown in FIG. 15. Further, in status ST4, when the zooming is performed to the frame G3 shown in FIG. 12 by an electronic zoom operation of the user, the subject OB is displayed on the LCD 10 as shown in FIG. 16.

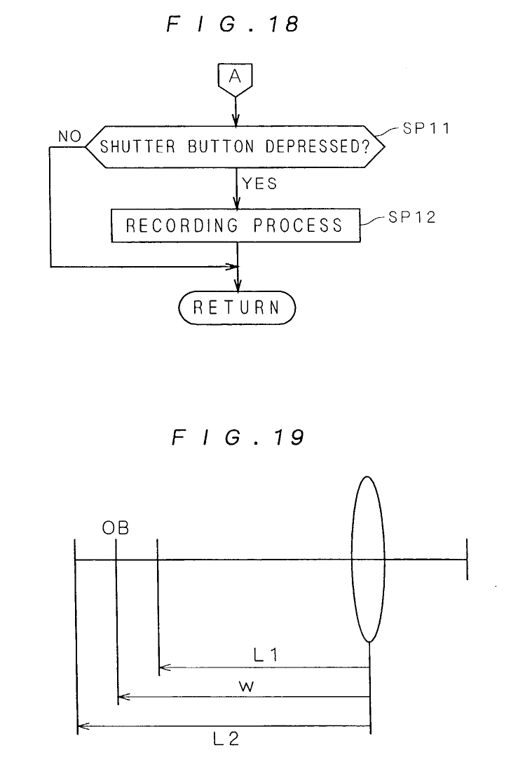

FIGS. 17 and 18 are flowcharts for concretely describing the operations of the digital camera 1. In FIGS. 17 and 18, out of the image capturing process of the digital camera 1, only operations corresponding to status ST4 to ST7 in the transition status diagram of FIG. 13 are shown. Concretely, steps SP2 to SP6, SP13 and SP15 correspond to status ST5 in FIG. 13, steps SP8 to SP10 and SP14 correspond to status ST6 in FIG. 13, and step SP12 corresponds to status ST7 in FIG. 13.

From status ST4 in FIG. 13 as a starting point, first, in step SP1, whether or not the four-way switch 230 is operated by the user is determined. If “YES” in step SP1, in step SP2, measurement of elapsed time is started by using the timer 211c in the overall control unit 211. In step SP3 subsequent to step SP2, the AF cursor CR is moved in the directions of the buttons 231 to 234 depressed by the user. On the other hand, if “NO” in step SP1, the program advances to step SP7 which will be described later.

In step SP4, whether or not predetermined time T (T=0.5 second in this example) has elapsed since the four-way switch 230 is depressed in step SP1 is determined. If “YES” in step SP4, it can be determined that the movement of the AF cursor CR to the desired position of the user has been completed. In this case, the program advances to step SP5 and whether or not the position designated by the AF cursor CR in the subject OB has a luminance level at which the AF process can be executed is determined. Such a determination is made by determining whether or not the position designated by the AF cursor CR has a luminance level equal to or higher than a predetermined value.

If “NO” in step SP5, the program advances to step SP7 which will be described later without performing the live view AF process in step SP6. Consequently, a situation such that a focusing operation is performed on a dark position at which the AF process does not effectively function can be avoided. On the other hand, if “YES” in step SP5, the program advances to step SP6 where the live view AF process is executed in the position of the AF cursor CR designated by the driving of the zoom lens 301. The live view AF process is executed in a state where the f-number is open so that the depth of field is reduced with respect to the f-number (that is, the depth of field is made shallowest). Although the AF process is not executed in step SP6, it is because the AE process is always executed when a live view is displayed. After the live view AF process, the screen of the LCD 10 is updated. Thus, the image of the subject OB on which focus is achieved in the designated AF cursor CR position is displayed on the screen of the LCD 10.

In step SP7, whether the shutter start button 8 is touched (S1) by the user or not is determined. If “YES” in step SP7, the program advances to step SP8 where the f-number set by the user and the present focal length of the zoom lens 301 are obtained. On the other hand, if “NO” in step SP7, the program returns to step SP 1.

In step SP9, whether the zoom operation is performed by the user or not after the live view AF process is executed in step SP6 is determined. The initial value of the zoom magnification has already been obtained before step SP6. By comparing the initial value with the focal length obtained in step SP8, whether the zoom operation is performed or not is determined.

If “YES” in step SP9 (that is, when the zoom operation is not performed), the program advances to step SP10 where the depth of field is examined.

The depth of field will be described here. Referring to FIG. 19, when the distance to the subject OB is w, the focal length of the lens is f, and the pitch of the CCD is d, the depth of field (on the front side) L1 and the depth of field (on the rear side) L2 are expressed by the following equations (1) and (2), respectively.

$$\begin{matrix}L1 = \frac{{wf}^{ 2}}{{f}^{2} + k \cdot F \cdot d \cdot ( w - f )} & ( equation 1 ) \\ L2 = \frac{{wf}^{ 2}}{{f}^{2} - k \cdot F \cdot d \cdot ( w - f )} & ( equation 2 )\end{matrix}$$

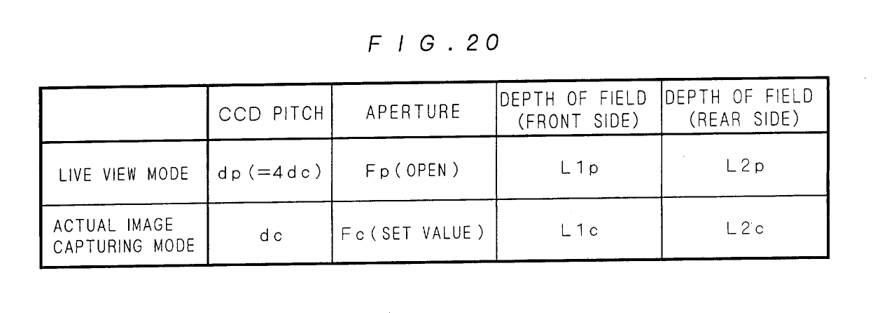

With respect to the digital camera 1, as shown in FIG. 20, when the CCD pitch at the time of actual image pickup is dc, a CCD pitch dp at the time of displaying a live view while reducing the number of pixels to ¼ is 4×dc. The f-number Fc in the actual image pickup is a value which is set by the user, and the f-number Fp at the time of a live view is an open value as described above. The depth of field (front side) and the depth of field (rear side) when a live view is displayed are set to L1p and L2p, respectively, and the depth of field (front side) and the depth of field (rear side) in an actual image pickup are set to L1c and L2c, respectively.

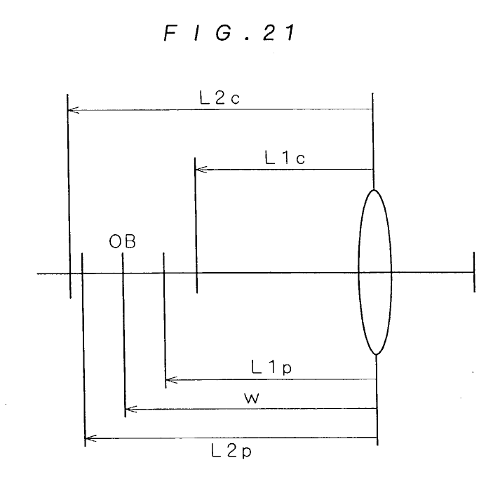

When the conditions of L1p>L1c and L2c>L2p are satisfied as shown in FIG. 21, if focus is achieved in the live view, focus is also achieved at the time of actual image pickup (on condition that the subject OB is quasi-stationary), so that it is unnecessary to newly perform the image pickup AF process at the time of actual image pickup. In step SP10, depending on the relations of depths of field based on L1p,L2p, L1c and L2c, whether the image pickup AF process has to be performed or not is examined.

If “YES” in step SP10 (that is, when the depth of field is satisfactory and the image pickup AF process is unnecessary), the program advances to step SP11 and whether or not the shutter start button 8 is fully depressed (S2) by the user is determined. When the live view AF process is performed not in the draft mode but in the all pixels reading mode, the result of determination in step SP10 is always “YES”. In this case, therefore, determination in step SP10 is unnecessary.

If “YES” in step SP11, the program advances to step SP12 where the captured image data is recorded and, after that, the program returns to the start (status ST4 in FIG. 13). When the actual image pickup and the recording process in step SP12 after steps SP4 to SP10 and SP11 are performed, the actual image pickup is performed in the focus state obtained by the live view AF process, so that the image pickup AF process is not performed.

On the other hand, if “NO” in step SP11, the program returns to start (status ST4 in FIG. 13) without performing step SP12.

If “NO” in step SP4, the program advances to step SP13 and whether or not the shutter start button 8 is touched (S1) by the user before elapse of the predetermined time T (0.5 second) since the four-way switch 230 is operated last is determined.

If “NO” in step SP13, the program advances to step SP15, and whether the four-way switch 230 is operated or not by the user is determined again. If “NO” in step SP15, the program returns to step SP4. On the other hand, if “YES” in step SP15, it is determined that movement of the AF cursor CR to the desired position of the user has not been completed yet. In this case, the program returns to step SP2 and the timer 211c is reset. After that, elapse of time since the four-way switch 230 is operated in step SP15 is newly measured.

In any of the cases where “YES” in step SP13, “NO” in step SP9, and “NO” in step SP10, the program advances to step SP14 where the image pickup AF process is newly executed with respect to the position on the designated AF cursor CR by the driving of the zoom lens 301 separately from the live view AF process. The AE is performed on the position of the AF cursor CR. Further, after the image pickup AF process, the screen display of the LCD 10 is updated. By the operations, the image of the subject OB on which focus is achieved by the image pickup AF process is displayed on the screen of the LCD 10.

In the digital camera 1 according to the embodiment, when the AF cursor CR is moved by the key operation of the user in a live view state (step SP1), interlockingly, the live view AF process is executed (step SP6). The image of the subject OB on which focus is achieved by the live view AF process is displayed on the screen of the LCD 10 (step SP6). Therefore, after moving the AF cursor CR, it is unnecessary for the user to touch the shutter start button 8 (S1) to display the focused image onto the LCD 10. As a result, regarding confirmation of the focus state after moving the AF cursor CR, operability can be improved.

The live view AF process in step SP6 is executed when (1) the shutter start button 8 is not touched and (2) the AF cursor CR is not newly moved before the predetermined time T elapses since the movement of the AF cursor CR by the operation of the four-way switch 230 is completed once. Consequently, the live view AF process can be prevented from being performed in a transient state where the process is substantially unnecessary.

Further, when predetermined allowable conditions are satisfied (“YES” in steps SP9 and SP10), the focus state achieved by the live view AF process is used for actual image pickup without performing the image pickup AF process (step SP14). Therefore, the image pickup AF process which is substantially the same as the live view AF process is not repeated.

In other words, the image pickup AF process in step SP14 is performed under the condition where the process is substantially necessary such that (1) the live view AF process in the position of the AF cursor CR is not performed when the shutter start button 8 is touched or (2) although the live view AF process in the position of the AF cursor CR is already performed when the shutter start button 8 is touched, the depth of field in the live view state and that at the time of the image pickup are different from each other so that the allowable conditions for using the focus state obtained by the live view AF process are not satisfied (“NO” in step SP9 or SP10).

Modifications

Although the metering area with respect to AE is set in correspondence with the AF cursor CR in the above description, separately from the AF cursor CR, the AE cursor expressing the center of the metering area as a metering point may be displayed.

In the electronic zoom, not only trimming but also pixel interpolation may be performed after the trimming.

While the invention has been shown and described in detail, the foregoing description is in all aspects illustrative and not restrictive. It is therefore understood that numerous modifications and variations can be devised without departing from the score of the invention.

What is claimed is:

1. An image capturing apparatus comprising:
an image sensor for capturing an image of a subject and generating image data;
a display for displaying an image based on the image data generated by said image sensor onto a screen;
a designating member for designating a focus position in said subject by moving a focus position designation indication on said screen; and
a focus controller for performing a focusing operation on the focus position designated by said designating member, wherein
said focus controller executes a first focusing operation on the focus position designated by said designating member in a preview state before actual image pickup.

2. The image capturing apparatus according to claim 1, wherein
said focus controller executes said first focusing operation interlockingly with the movement of said focus position designation indication by said designating member.

3. The image capturing apparatus according to claim 1, further comprising a timer, wherein
when another focus position is not designated by said designating member until predetermined time elapses since the designation of the focus position by said designating member, said focus controller executes said first focusing operation.

4. The image capturing apparatus according to claim 3, further comprising
an image capture instructing member for instructing actual image capture, wherein
when actual image capture is instructed by said image capture instructing member, said focus controller executes a second focusing operation on the focus position designated by said designating member.

5. The image capturing apparatus according to claim 4, wherein
said focus controller executes said second focusing operation when actual image capture is instructed by said image capture instructing member before predetermined time elapses since designation of the focus position by said designating member.

6. The image capturing apparatus according to claim 1, further comprising
an image capture instructing member for instructing actual image capture, wherein
when actual image capture is instructed by said image capture instructing member, said focus controller executes a second focusing operation on the focus position designated by said designating member.

7. The image capturing apparatus according to claim 6, wherein
the number of pixels of said image sensor used for said first focusing operation is smaller than that of said image sensor used for said second focusing operation.

8. The image capturing apparatus according to claim 6, wherein
said first focusing operation is performed in a state where an aperture is open.

9. The image capturing apparatus according to claim 6, wherein
said display displays an image of a subject subjected to said second focusing operation onto said screen.

10. The image capturing apparatus according to claim 6, further comprising
a zoom operating member for performing a zooming operation of an imaging lens, wherein
said focus controller executes said second focusing operation when said zoom operating member is operated after said first focusing operation is performed.

11. The image capturing apparatus according to claim 1, wherein
said focus controller does not perform a focusing operation at the time of actual image capture.

12. The image capturing apparatus according to claim 11, wherein
said focus controller determines whether the focusing operation is performed at the time of actual image capture on the basis of a depth of field.

13. The image capturing apparatus according to claim 1, further comprising
a detector for detecting luminance of a subject on the focus position designated by said designating member.

14. The image capturing apparatus according to claim 13, wherein
when the luminance of the subject in the focus position designated by said designating member is equal to or lower than a predetermined value, said focus controller does not execute said first focusing operation.
